(19) United States
(12) Patent Application Publication
(10) Pub. No.: US 2024/0011268 A1
(43) Pub. Date: Jan. 11, 2024

(54) DRAIN UNCLOGGER TOOL

(71) Applicants: MOHAMMED NAOUI, SURREY (CA); IBRAHIM NAOUI, SURREY (CA); OMAR NAOUI, SURREY (CA)

(72) Inventors: MOHAMMED NAOUI, SURREY (CA); IBRAHIM NAOUI, SURREY (CA); OMAR NAOUI, SURREY (CA)

(21) Appl. No.: 18/148,361

(22) PCT Filed: Jul. 26, 2021
(86) PCT No.: PCT/CA2021/000061

§ 371 Date: Dec. 29, 2022

(30) Foreign Application Priority Data
Jul. 27, 2020 (CA) 3088443

(51) Int. Cl. E03C 1/302; B08B 9/045

(52) U.S. Cl. CPC E03C 1/302; B08B 9/045; B08B 2209/04

(57) ABSTRACT

The drain unclogger tool is a tool that removes hair and debris from drains. The drain unclogger tool is characterized by a coiled spring base, with a straight shaft as the stem, and a crank handle as a grasping point for the tool. The simplicity of the tool that could be made by only one single piece makes it unique. The tool solves the issue of hair and debris that get trapped in sinks and bathtubs drains. Insert tool into drain opening. In some cases drain openings are covered with a circular cover plate that prevents large objects from falling into the drain, unscrew cover plate counter clockwise to remove it. With tool inserted into drain opening use crank handle to rotate clockwise and hair and debris will entangle and wrap around coil base of tool. Pull out tool from drain along with trapped hair and debris in the tool coil and clean after use.

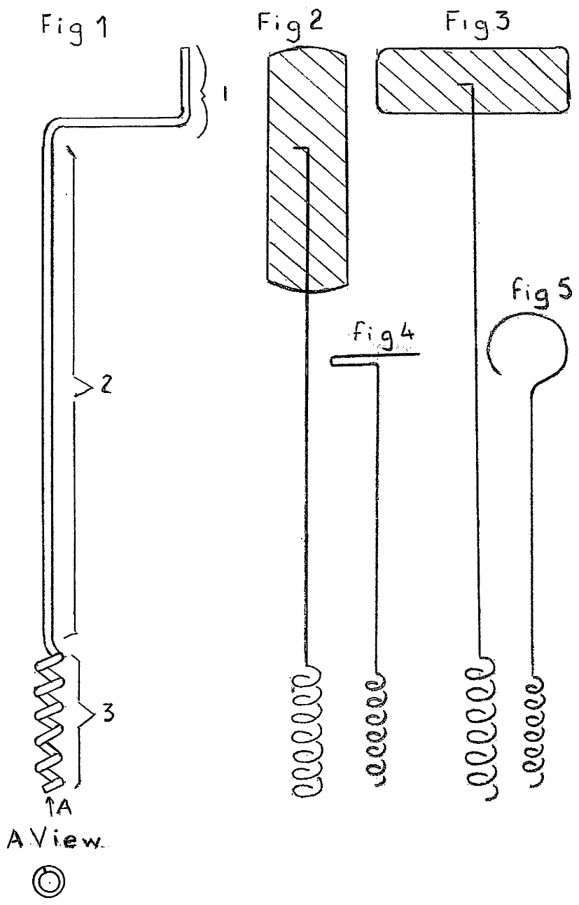

The drain unclogger tool is an invention that relates to other drain unclogging tools which are used to free drains from clogs. Some drain unclogging tools consist of drain plungers for example. The drain unclogger tool gives a quick and reliable mechanical method of removing hair and debris that accumulates in sink and bathtub drains. With reference to FIG. 1 drawing, the tool consits of a wire coil base (3) with a straight shaft (2) as the stem of the tool, and a crank handle (1) as the grasping point of the tool. To remove hair and debris from sink and bathtub drains insert tool into drain opening. In some cases, drain openings are covered with a circular cover plate that prevents large objects from falling into the drain. Unscrew cover plate counter clockwise to remove it. With tool inserted into drain opening, use crank handle to rotate clockwise and hair and debris will entangle and wrap around coil base of tool. Pull out tool from sink along with trapped hair and debris in the tool coil. Dispose of debris and clean tool coil spring for next time use.

The drain unclogger tool provides simplicity and effectiveness when it comes to clearing drains of hair and fiber debris.

Thanks to the coil shape of the lower part of the tool, hair or long fibers get twisted and entangled. This is the main characteristic of this tool. The second main characteristic is the unique design that makes the tool made only of one single piece such as mostly FIG. 1, and FIG. 4, and FIG. 5. We emphasize on the fact that the tool could be made by only one single piece.

1. With reference to the drawing FIG. 1 the drain unclogger tool consists of:
1) A coiled spring base (3) for trapping debris and hair.
2) A straight solid shaft (2) as the stem of the tool.
3) The crank handle (1) as the grasping point of the tool.
4) Any grasping handle for turning this tool such as FIG. 2 (molded plastic or wood), FIG. 3 (molded plastic or wood), FIG. 4, FIG. 5 or other shape.
5) The entire tool consisting of a coiled spring base (3) for trapping debris and hair, A straight solid shaft (2) as the stem of the tool, The crank handle (1) as the grasping point of the tool.
6) The unique design that makes the tool made only of one single piece such as mostly FIG. 1, and FIG. 4, and FIG. 5. This claim emphasizes on the fact that the tool is made by only one single piece.
